(19) United States
(12) Patent Application Publication
(10) Pub. No.: US 2004/0049585 A1
(43) Pub. Date: Mar. 11, 2004

(54) SERVER SIDE CONFIGURATION OF CLIENT IPSec LIFETIME SECURITY PARAMETERS

(75) Inventor: Brian D. Swander, Kirkland, WA (US)

Correspondence Address: LEYDIG, VOIT & MAYER, LTD., TWO PRUDENTIAL PLAZA, SUITE 4900, 180 NORTH STETSON, CHICAGO, IL, 60601-6780, US

(73) Assignee: Microsoft Corporation, Redmond, WA (US)

(21) Appl. No.: 09/549,760

(22) Filed: Apr. 14, 2000

(51) Int. Cl. G06F 15/173

(52) U.S. Cl. 709/229; 713/201

(57) ABSTRACT

### Abstract of the Disclosure

A method of server side configuration of client IPSec security association parameters is compliant with the IPSec protocol and entails configuring the client IKE module to use default lifetimes and configuring the server IKE module to append a ResponderLifetimeNotify to a Quick Mode security association proposal proposed by the client IKE module. In this manner, a Quick Mode security association is established in the client computer IKE module in keeping with the lifetime values submitted by the server IKE module in the ResponderLifetimeNotify.

### Detailed Description of the Invention

### Background of Invention

This invention relates generally to network data transmission security and, more particularly, relates to server side configuration of client lifetime security parameters within the IPSec protocol.

The prevalence of network technology has increased dramatically in recent years. From the Internet to intranets, computers throughout the world have become massively interconnected. Businesses, institutions, and private users alike routinely place sensitive information onto networks and rely upon the security of the network to protect the security of such information. There are a number of ways in which network information can be compromised by unscrupulous third parties. Data may be surreptitiously modified en route by a malicious interceptor. Alternatively, transmitted data may be intercepted and viewed or copied by an unauthorized party. Furthermore, an unauthorized party may masquerade as an authorized party, and hence illicitly gain access to sensitive information via a network connection. The general types of protection needed to combat these security risks are commonly referred to as "data integrity," "confidentiality," and "authentication" respectively.

A majority of network traffic utilizes the Internet Protocol (IP) for data transmission. The Internet Protocol, part of the TCP/IP communications protocol, implements the network layer (layer 3) of the protocol, which contains a network address used to route messages. IP has no default security scheme associated with it, and accordingly, IP packets are often easily intercepted, read, copied, corrupted, mimicked and so on.

The IP Security Protocol (IPSec) was designed by the Internet Engineering Task Force (IETF) for IP. IPSec supports network-level authentication, data integrity, and encryption, as well as anti-replay and non-repudiation protection. In contrast to Secure Sockets Layer (SSL) and other transport layer security protocols, IPSec operates at the network layer to secure most types of IP packets. IPSec, as defined by the IETF, uses an authentication header (AH) format and/or an encapsulated security payload (ESP) format to secure IP datagrams. The authentication header provides data communication with source authentication and integrity, while the encapsulated security payload provides confidentiality as well as a limited degree of source authentication.

The keying scheme specified by the IETF for IPSec is the Internet Key Exchange protocol (IKE), documented mainly in IETF RFC 2409. This describes a method whereby the sender and recipient negotiate trust and security settings, including the generation of shared secret cryptographic keys to be used for application data encryption in the AHD and ESP IPSec formats. If the authentication data in each IPSec packet is valid, the recipient can be confident that the communication originated from the sender and that it was not altered after transmission.

Windows 2000 implements the Identify Protect Mode of the Internet Key Exchange protocol. In this version of IKE, before application data IP packets can be transmitted from one computer to another, three security associations (SAs) must be established between the communicating parties. The first is called the IKE security association (Main Mode or Phase 1 SA), which serves as a high level trusted channel established between the two parties. Then two IPSec security associations (Quick Mode, or Phase 2 SAs) are established; one from peer A to peer B, the other from B back to A. An SA is a set of parameters that defines the services and mechanisms, such as keys, to be used to protect communications. The Internet Security Association Key Management Protocol (ISAKMP) defines a framework for supporting the establishment of security associations without being linked to any specific algorithm or key generation method. The Oakley Key Exchange protocol provides a secure method for exchanging cryptographic key material such that an observer of the communication cannot easily discover the secret shared key generated by the two parties. The Internet Key Exchange (RFC 2409) and the IPSec Domain of Interpretation for ISAKMP (RFC 2408) provide detailed specifications for ISAKMP and Oakley are integrated to produce a single IPSec-specific key exchange protocol.

IPSec IKE provides for dynamic rekeying during ongoing communications to ensure security. When a key associated with a given security association expires, or is about to expire, a new key must be negotiated. The expiration time is referred to as the security association lifetime. The RFC's require that either side be able to initiate rekey, regardless of which side initiated the original key negotiation. The RFC's further indicate that each side must be able to configure security association lifetimes with both time (seconds) and data (bytes encrypted by the key) limits. According to the RFC's, the initiator of an IKE key negotiation may propose these lifetime settings, but it is not required to propose them. Likewise, the responder may accept them or it may not. Finally, the responder may notify the initiator of the actual lifetime it chose, or it may not. This degree of ambiguity in the IETF RFC specifications leaves opportunity for innovation for how best to agree on security association lifetimes. As IPSec is currently implemented, the initiator (usually the client) must propose security parameters, including lifetimes, which the responder (usually the server) must either accept or reject. Therefore, lifetimes in IPSec are largely client-side configured.

Unfortunately, this model of negotiation is often at odds with the needs of the client and server. For example, different servers may have drastically different bandwidths, and accordingly may provide data to a given client at very different rates. If the client proposes the same kilobyte lifetime to both servers, the faster machine will require more frequent rekeying, and in an extreme case may require continuous rekeying or may simply discard data until the next rekey establishes a new lifetime for the transmission of data. Since the responder, or server, is likely to be the party with most information regarding the amount of data to be transferred and the amount of time required to make the transfer, a method of server-side configuration of lifetime security parameters within IPSec is needed.

### Summary of Invention

The invention provides a method wherein both client and server adhere to the IETF RFC requirements, but the server-side configuration determines the IPSec IKE Quick Mode (Phase 2) security association lifetime parameters. In an embodiment of the invention, a client is configured to send no lifetime parameters during negotiation, and a server is configured to supply its preferred lifetime parameters using the IPSec responder lifetime notify mechanism.

Additional features of the invention will be made apparent from the following detailed description of illustrative embodiments which proceeds with reference to the accompanying figures.

### Brief Description of Drawings

While the appended claims set forth the features of the present invention with particularity, the invention, together with its objects and advantages, may be best understood from the following detailed description taken in conjunction with the accompanying drawings of which:

Figure 1 is a block diagram generally illustrating an exemplary computer system on which the present invention resides;

Figure 2 is a network schematic illustrating functional components usable within an embodiment of the invention;

Figure 3 is a simplified illustration of typical negotiation traffic within IPSec; and

Figure 4 is a simplified illustration of negotiation traffic within IPSec using a method according to an embodiment of the invention to allow server side configuration of client lifetime parameters.

### Detailed Description

Turning to the drawings, wherein like reference numerals refer to like elements, the invention is illustrated as being implemented in a suitable computing environment. Although not required, the invention will be described in the general context of computer-executable instructions, such as program modules, being executed by a personal computer. Generally, program modules include routines, programs, objects, components, data structures, etc. that perform particular tasks or implement particular abstract data types. Moreover, those skilled in the art will appreciate that the invention may be practiced with other computer system configurations, including hand-held devices, multi-processor systems, microprocessor based or programmable consumer electronics, network PCs, minicomputers, mainframe computers, and the like. The invention may also be practiced in distributed computing environments where tasks are performed by remote processing devices that are linked through a communications network. In a distributed computing environment, program modules may be located in both local and remote memory storage devices.

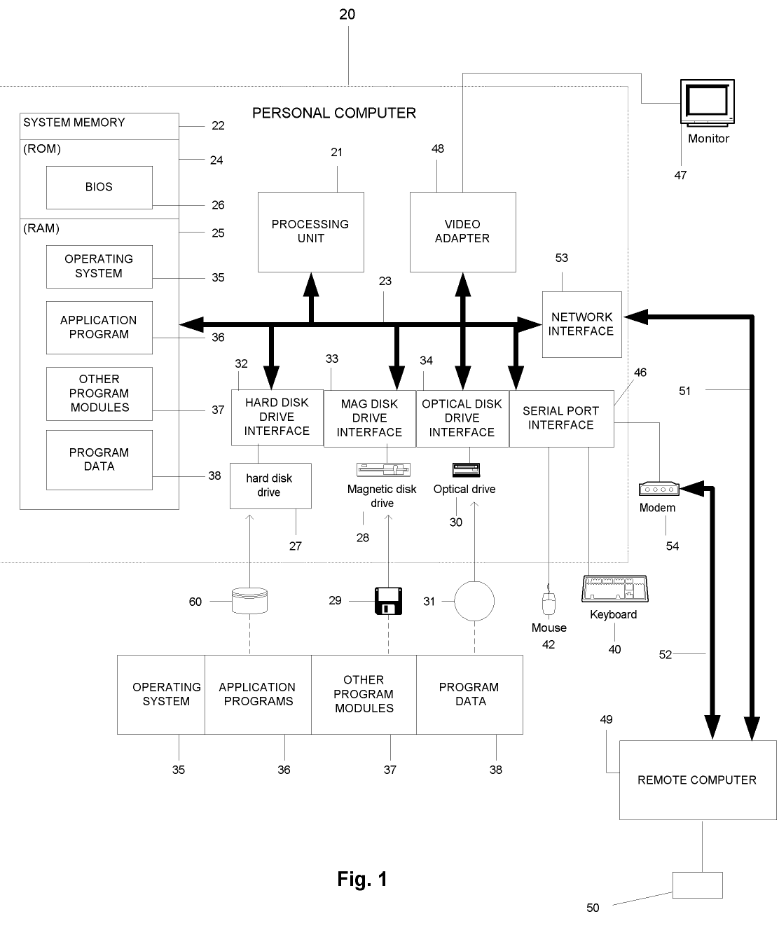

With reference to Fig. 1, an exemplary system for implementing the invention includes a general purpose computing device in the form of a conventional personal computer 20, including a processing unit 21, a system memory 22, and a system bus 23 that couples various system components including the system memory to the processing unit 21. The system bus 23 may be any of several types of bus structures including a memory bus or memory controller, a peripheral bus, and a local bus using any of a variety of bus architectures. The system memory includes read only memory (ROM) 24 and random access memory (RAM) 25. A basic input/output system (BIOS) 26, containing the basic routines that help to transfer information between elements within the personal computer 20, such as during start-up, is stored in ROM 24. The personal computer 20 further includes a hard disk drive 27 for reading from and writing to a hard disk 60, a magnetic disk drive 28 for reading from or writing to a removable magnetic disk 29, and an optical disk drive 30 for reading from or writing to a removable optical disk 31 such as a CD ROM or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer readable instructions, data structures, program modules and other data for the personal computer 20. Although the exemplary environment described herein employs a hard disk 60, a removable magnetic disk 29, and a removable optical disk 31, it will be appreciated by those skilled in the art that other types of computer readable media which can store data that is accessible by a computer, such as magnetic cassettes, flash memory cards, digital video disks, Bernoulli cartridges, random access memories, read only memories, and the like may also be used in the exemplary operating environment.

A number of program modules may be stored on the hard disk 60, magnetic disk 29, optical disk 31, ROM 24 or RAM 25, including an operating system 35, one or more applications programs 36, other program modules 37, and program data 38. A user may enter commands and information into the personal computer 20 through input devices such as a keyboard 40 and a pointing device 42. Other input devices (not shown) may include a microphone, joystick, game pad, satellite dish, scanner, or the like. These and other input devices are often connected to the processing unit 21 through a serial port interface 46 that is coupled to the system bus, but may be connected by other interfaces, such as a parallel port, game port or a universal serial bus (USB). A monitor 47 or other type of display device is also connected to the system bus 23 via an interface, such as a video adapter 48. In addition to the monitor, personal computers typically include other peripheral output devices, not shown, such as speakers and printers.

The personal computer 20 operates in a networked environment using logical connections to one or more remote computers, such as a remote computer 49. The remote computer 49 may be another personal computer, a server, a router, a network PC, a peer device or other common network node, and typically includes many or all of the elements described above relative to the personal computer 20, although only a memory storage device 50 has been illustrated in Fig. 1. The logical connections depicted in Fig. 1 include a local area network (LAN) 51 and a wide area network (WAN) 52. Such networking environments are commonplace in offices, enterprise-wide computer networks, intranets and the Internet.

When used in a LAN networking environment, the personal computer 20 is connected to the local network 51 through a network interface or adapter 53. When used in a WAN networking environment, the personal computer 20 typically includes a modem 54 or other means for establishing communications over the WAN 52. The modem 54, which may be internal or external, is connected to the system bus 23 via the serial port interface 46. In a networked environment, program modules depicted relative to the personal computer 20, or portions thereof, may be stored in the remote memory storage device. It will be appreciated that the network connections shown are exemplary and other means of establishing a communications link between the computers may be used.

In the description that follows, the invention will be described with reference to acts and symbolic representations of operations that are performed by one or more computers, unless indicated otherwise. As such, it will be understood that such acts and operations, which are at times referred to as being computer-executed, include the manipulation by the processing unit of the computer of electrical signals representing data in a structured form. This manipulation transforms the data or maintains it at locations in the memory system of the computer, which reconfigures or otherwise alters the operation of the computer in a manner well understood by those skilled in the art. The data structures where data is maintained are physical locations of the memory that have particular properties defined by the format of the data. However, while the invention is being described in the foregoing context, it is not meant to be limiting as those of skill in the art will appreciate that various of the acts and operations described hereinafter may also be implemented in hardware. For more background information regarding the IPSec protocol, the reader is invited to consult the IETF Requests For Comments (RFC's) regarding IPSec, i.e. RFC's 1828, 1829, 2085, 2104, 2401-2412, and 2451, which are hereby incorporated by reference in their entireties.

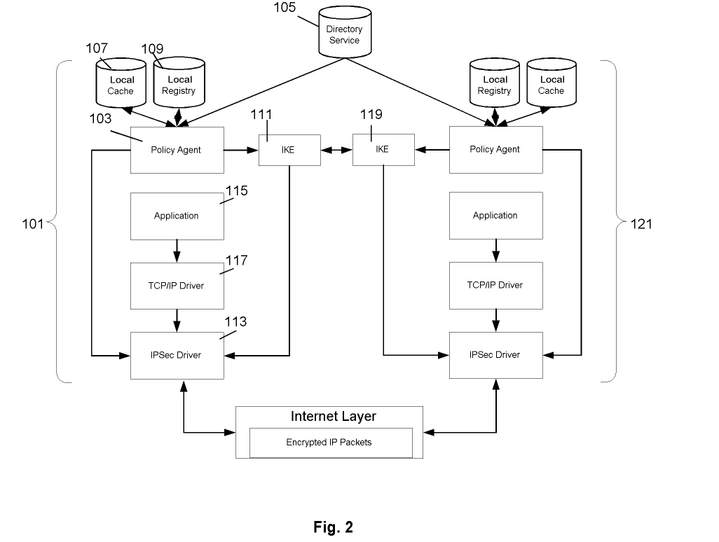

Referring to Fig. 2, the IPSec architecture for a given computer 101 includes a policy agent 103 for obtaining IPSec policy information from a Directory Service 105 optionally, a local cache 107, or a local registry 109. In turn, an IKE module 111 and an IPSec driver 113 both receive policy information from the policy agent 103.

In overview with respect to the IPSec protocol, an application 115 may direct a packet of information to the network via the TCP/IP driver 117. This information is passed to the IPSec driver 113. The IPSec driver 113 determines when network traffic requires IPSec protection via filters within the IPSec driver 113. These filters determine whether security is required for a given packet based on parameters such as source address, source mask, destination address, destination mask, protocol, source port, destination port, and filter type. In a simple example, an IPSec filter may mandate security for all Telnet packets that are from machine A, to machine B. If an outgoing packet matches a filter and no appropriate valid security association exists, IKE 111 is invoked to negotiate an appropriate security association. This negotiation takes place between the IKE module 111 and the IKE module 119 of the peer machine 121. According to the IPSec protocol, IKE may be invoked to negotiate a new security association in other circumstances as well.

Once an association has been established, IKE sends the SA to the IPSec driver and the association is thereafter used by the IPSec driver 113 to secure outgoing traffic until the association expires. The IPSec driver may initiate rekeying based on the negotiated duration lifetime, byte count lifetime, policy changes, or other situations which create a need for a new security association.

The expiration of a security association is governed by its lifetime parameters, which are the result of IKE negotiation. IPSec supports two modes or phases: Main Mode and Quick Mode. A Main Mode security association is first negotiated if one does not exist, after which Quick Mode security associations are negotiated within the Main Mode. Both modes have associated lifetimes, although it is the Quick Mode lifetime parameter that is of concern with respect to the invention.

In greater detail, an IPSec policy contains the following: (1) policy-wide parameters such as a polling interval used to detect policy changes; (2) an ISAKMP rule, which contains IKE parameters for use during negotiation of Main Mode security associations; and (3) one or more IPSec rules. Each IPSec rule is an association of the following: (a) a filter list; (b) negotiation data usable during Quick Mode negotiation, including security association lifetime information; (c) an authentication method; (d) a Tunnel Endpoint Flag; and (e) Interface Applicability information indicating to which type of interfaces the rule applies.

Briefly, Main Mode negotiation consists of six messages. Three of these messages are from the client or initiator and three are from the server or responder. The first four messages are not encrypted and are as follows: (1) security association proposals from the initiator to the responder; (2) a security association package from the responder to the initiator selected from the received proposals; (3) key exchange from the initiator to the responder and ; (4) key exchange from the responder to the initiator. The fifth and sixth messages are encrypted, and vary according to the authentication method selected, as is well known to those of skill in the art. Some possible authentication methods are Kerberos authentication, certificate based digital signature authentication, and preshared key authentication.

As mentioned above in overview, upon completion of Main Mode negotiation or upon actual or impending expiry of a Quick Mode security association, Quick Mode negotiation may be initiated. During Quick Mode negotiation, all messages are protected through use of the ISAKMP security association established during Main Mode negotiation. Each Quick Mode security association comprises two IPSec security associations, one for outgoing traffic and another for incoming traffic. During negotiation, the IKE module 111 of the initiator will propose one or more security association proposals based on the protocols and transforms designated in the applicable security policy. In reply, the IKE module 119 of the responder 121 will select and return an acceptable proposal if in fact at least one of the initiator proposals is acceptable. An example security association structure SA_STRUCT is as follows:

typedef struct_SA_STRUCT {

| | |
|---|---|
| HANDLE | Context; //context of the original ACQUIRE |

Request

| | |
|---|---|
| ULONG | NumSAs; //number of SAs following |
| SA_FLAGS | Flags; |
| IPAddr | TunnelAddr; //Tunnel end IP address |
| LIFETIME | Lifetime; |
| IPSEC_FILTER | InstantiatedFilter; //the actual addresses for which |

//this SA was created

| SECURITY_ASSOCIATION SecAssoc[MAX_SAS]; | |
|---|---|
| DWORD | dwQMPFSGroup; |
| IKE_COOKIE_PAIR CookiePair; | |
| ULONG | KeyLen; // key length in number of characters |
| UCHAR | KeyMat[1]; |

} SA_STRUCT, *PSA_{– STRUCT;}

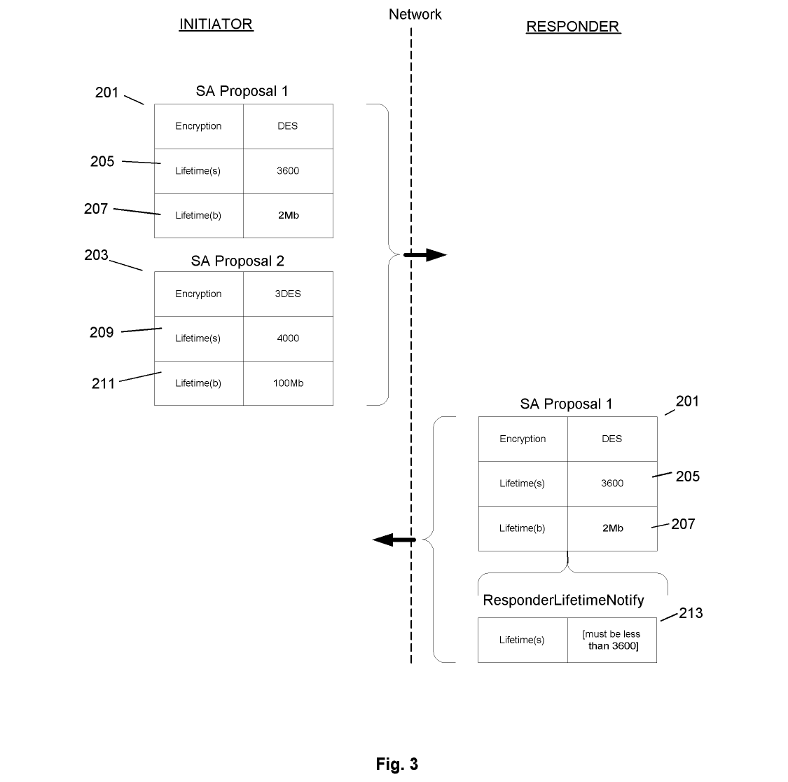

A simplified example IPSec Quick Mode security association negotiation exchange is illustrated schematically in Fig. 3. Security association proposals 201, 203 are transmitted from the initiator IKE module 111 to the responder IKE module 119. The illustrated proposal parameters are for purposes of explication and one of skill in the art will appreciate that additional parameters not illustrated will typically be included in each proposal. Upon receipt of the proposals, the responder IKE module 119 selects a proposal that satisfies the relevant security policy aspects for the association under negotiation. If more than one proposal satisfies the relevant security policy aspects, the IKE module 119 may select the first such proposal that it analyzes. Typically, the responder IKE module 119 then transmits the selected proposal back to the initiator IKE module 111.

Within the IPSec protocol, the responder IKE module 119 cannot change the parameters of the proposals. Rather, it must select and return an acceptable proposal in its entirety from the offered security association proposals if an acceptable proposal exists. If no proposal is acceptable, e.g. if all of the received lifetime proposals are less than the locally configured minimums, the negotiation may fail. With respect to the lifetime second and kilobyte parameters 205, 207, 209, 211, this means that the responder or server has a very restricted role in setting the rekeying interval. IPSec provides for a limited exception to this rule; if the initiator-proposed lifetimes 205, 207 of the selected proposal 201 exceed the maximum lifetimes allowed by the relevant security policy applied to the responder, the responder IKE module 119 can return the proposal 201 with a ResponderLifetimeNotify 213 appended thereto. The effect of the ResponderLifetimeNotify is to decrease the negotiated lifetime to a duration that does not violate the relevant responder security policy, avoiding negotiation failure. However, the ResponderLifetimeNotify mechanism may not be used to increase the negotiated lifetime over that specified in the returned proposal.

The responder machine is more likely to be the server than the client, and is therefore more likely than the initiator to be in possession of information regarding the size of the data set to be transmitted under the negotiated Quick Mode security association. It is therefore desirable that the responder be able to arbitrarily set rekeying intervals in keeping with that information. According to an embodiment of the invention, the ResponderLifetimeNotify facility is exploited to provide a mechanism for conferring upon the responder essentially absolute control over the rekeying interval within the IPSec protocol for Quick Mode security associations.

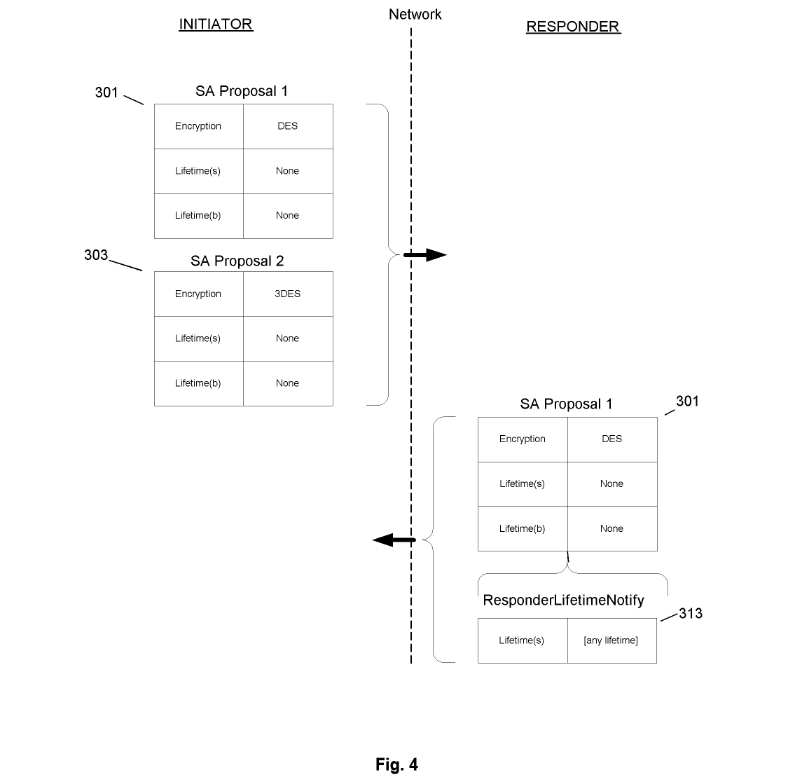

In particular, according to an embodiment of the invention, the client or initiator is configured to use default lifetimes. Thus, with reference to Fig. 4, during Quick Mode negotiation the security association proposals 301, 303 sent from the initiator IKE module 111 to the responder IKE module 119 do not contain explicit lifetimes. In addition, the responder 121 is configured to append a ResponderLifetimeNotify 313 to a selected returned proposal 301. The ResponderLifetimeNotify mechanism is not being used to increase any proposed lifetime in violation of IPSec because no lifetimes were proposed. Thus, the ResponderLifetimeNotify may specify any value that is not outside of the range allowed by the relevant security policy on the initiator 101.

The configuration of the initiator and responder may be done via their respective security policies. For example, the negotiation data of the relevant IPSec rule within the IPSec policy should be configured to provide the described negotiation behavior. Thus, the negotiation data of the relevant IPSec rule within the initiator IPSec policy is set such that the IKE module of the initiator will use default lifetimes, thereby not proposing explicit lifetimes during negotiation. In this manner, if the responder fails to specify any lifetime values, the default values will be used by the initiator. Likewise, the negotiation data of the relevant IPSec rule within the responder IPSec policy is set such that the IKE module of the responder will append a ResponderLifetimeNotify to any returned security association proposal, thereby enforcing the responder's lifetime preference. As will be appreciated, by configuring an initiator and responder according to the disclosed principles, a network system may be fully compliant with the IPSec protocol while still allowing the responder greatly increased latitude to set lifetimes, relative to the responder participation anticipated by the protocol.

In view of the various embodiments to which the principles of this invention may be applied, it should be recognized that the embodiment described herein with respect to the drawing figures is meant to be illustrative only and should not be taken as limiting the scope of invention. For example, those of skill in the art will recognize that the elements of the illustrated embodiment shown in software may be implemented in hardware and vice versa or that the illustrated embodiment can be modified in arrangement and detail without departing from the spirit of the invention. Therefore, the invention as described herein contemplates all such embodiments as may come within the scope of the following claims and equivalents thereof.

What is Claimed is:

1. A method of responder side configuration of initiator security association parameters for use in a network system having an initiator computer and a responder computer communicably interconnected via a network connection, the initiator and responder computers each implementing the IPSec protocol, and each comprising an IKE module for Quick Mode security association negotiation, the method comprising the steps of:
establishing a first security policy for implementation on the initiator computer, wherein the first security policy requires that the IKE module of the initiator use a default lifetime for a Quick Mode security association;
establishing a second security policy for implementation on the responder computer, wherein the second security policy requires that the IKE module of the responder computer append a ResponderLifetimeNotify to a security association proposal during the Quick Mode security association negotiation, wherein the ResponderLifetimeNotify specifies a preferred lifetime;
transmitting the security association proposal from the initiator IKE module to the responder IKE module during the Quick Mode security association negotiation;
appending a ResponderLifetimeNotify to the security association proposal in keeping with the second security policy; and
returning the security association proposal from the responder IKE module to the initiator IKE module, thereby establishing a Quick Mode security association between the initiator computer and responder computer having a lifetime corresponding to the preferred lifetime.

2. The method according to claim 1 wherein the network connection communicably interconnecting the initiator computer and responder computer comprises a local area network.

3. The method according to claim 1 wherein the network connection communicably interconnecting the initiator computer and responder computer comprises a metropolitan area network.

4. The method according to claim 1 wherein the network connection communicably interconnecting the initiator computer and responder computer comprises a wide area network.

5. The method according to claim 1 wherein the network connection communicably interconnecting the initiator computer and responder computer comprises the Internet.

6. A method of responder side configuration of an initiator security association lifetime parameter for a Quick Mode security association, for use with an initiator computer in a network system comprising the initiator computer and a responder computer communicably interconnected via a network connection, the initiator and responder computers each implementing the IPSec protocol, and each comprising an IKE module for Quick Mode security association negotiation, the method comprising the steps of:
transmitting from the initiator computer to the responder computer a Quick Mode security association proposal, wherein the security association proposal does not list an explicit security association lifetime;
receiving at the initiator computer from the responder computer the security association proposal, having appended thereto a ResponderLifetimeNotify specifying a preferred lifetime parameter; and
responsively establishing in the initiator computer IKE module a Quick Mode security association having a lifetime parameter corresponding to the preferred lifetime parameter.

7. The method according to claim 6 wherein the network connection communicably interconnecting the initiator computer and responder computer comprises a local area network.

8. The method according to claim 6 wherein the network connection communicably interconnecting the initiator computer and responder computer comprises a metropolitan area network.

9. The method according to claim 6 wherein the network connection communicably interconnecting the initiator computer and responder computer comprises a wide area network.

10. The method according to claim 6 wherein the network connection communicably interconnecting the initiator computer and responder computer comprises the Internet.
